(19) United States
(12) Patent Application Publication
(10) Pub. No.: US 2016/0277460 A1
(43) Pub. Date: Sep. 22, 2016

(54) METHOD AND APPARATUS FOR INITIATING NETWORK CONFERENCE

(71) Applicant: Huawei Technologies Co., Ltd., Shenzhen (CN)

(72) Inventor: Yifeng YING, Hangzhou (CN)

(21) Appl. No.: 15/166,873

(22) Filed: May 27, 2016

Related U.S. Application Data
(63) Continuation of application No. PCT/CN2014/077357, filed on May 13, 2014.

(30) Foreign Application Priority Data
Nov. 29, 2013 (CN) 201310632759.7

(51) Int. Cl. H04L 29/06; G06Q 10/10; H04L 12/58

(52) U.S. Cl. CPC H04L 65/403; H04L 51/18; G06Q 10/1095

(57) ABSTRACT

The present application provides a method including: acquiring mail information related to the network conference; identifying sender address information, recipient address information, and mail title information in the mail information; determining a sender address indicated by the sender address information as a first participant address of the network conference; determining a recipient address indicated by the recipient address information as a second participant address of the network conference; determining a mail title indicated by the mail title information as a conference subject of the network conference; and sending a conference reservation request that includes the conference subject, the first participant address and the second participant address to a conference reservation server. Information related to the network conference may be automatically generated by using the method or the apparatus in the present application.

### CROSS-REFERENCE TO RELATED APPLICATIONS

This application is a continuation of International Patent Application No. PCT/CN2014/077357, filed on May 13, 2014, which claims priority to Chinese Patent Application No. 201310632759.7, filed on Nov. 29, 2013, both of which are hereby incorporated by reference in their entireties.

### TECHNICAL FIELD

The present application relates to the field of data processing, and in particular, to a method and an apparatus for initiating a network conference.

### BACKGROUND

With continuous development of network technologies, a conventional conference mode is gradually replaced by a network conference mode. The network conference refers to an instant messaging process that is initiated by using a network and in which multiple user terminals participate.

In the prior art, a method for initiating a network conference is mainly that an initiator manually enters related information of the conference. The related information of the conference mainly includes participant address information, title information, and the like of the conference.

However, each time when a network conference is initiated, the foregoing related information of the conference needs to be manually entered, thereby causing low efficiency of initiating the network conference and occupying much time of the initiator.

### SUMMARY

An objective of the present application is to provide a method and an apparatus for initiating a network conference, so that related information of the conference can be automatically generated, which solves a problem that manual entering of the related information of the conference occupies much time of an initiator.

To achieve the foregoing objective, the present application provides the following solutions:

According to a first possible implementation manner of a first aspect of the present application, the present application provides a method for initiating a network conference, where the method includes:

acquiring mail information related to the network conference;

identifying sender address information, recipient address information, and mail title information in the mail information;

determining a sender address indicated by the sender address information as a first participant address of the network conference;

determining a recipient address indicated by the recipient address information as a second participant address of the network conference;

determining a mail title indicated by the mail title information as a conference subject of the network conference; and

sending a conference reservation request to a conference reservation server, where the conference reservation request includes the conference subject, the first participant address and the second participant address, and the conference reservation request is used to request the conference reservation server to create the network conference and send a conference notification that includes the conference subject to the first participant address and the second participant address.

With reference to a second possible implementation manner of the first aspect, after the sending a conference reservation request to a conference reservation server, the method further includes:

uploading the mail information to the conference reservation server, so that a terminal participating in the network conference acquires the mail information from the conference reservation server.

With reference to a first specific implementation manner of the second possible implementation manner of the first aspect, the sending a conference reservation request to a conference reservation server specifically includes:

sending a conference reservation request that includes a conference type identifier to the conference reservation server, where the conference type identifier is used to indicate that the network conference is initiated based on a mail, so that the conference reservation server sends the conference type identifier to the terminal participating in the network conference, and after the terminal participating in the network conference determines, according to the conference type identifier, that the network conference is initiated based on a mail, the terminal performs a step of acquiring the mail information from the conference reservation server.

With reference to a second specific implementation manner of the second possible implementation manner of the first aspect, before the uploading the mail information to the conference reservation server, the method further includes:

identifying text information in the mail information;

determining text attribute information of the text information, where the text attribute information includes at least a font type, a font size, a font color, and a text location; and

converting a format of the text attribute information into a text attribute information format supported by software that bears the network conference.

With reference to a third specific implementation manner of the second possible implementation manner of the first aspect, before the uploading the mail information to the conference reservation server, the method further includes:

identifying graphical information in the mail information;

determining graph attribute information of the graphical information, where the graph attribute information includes at least a graph type, a graph size, and a graph location; and

converting a format of the graph attribute information into a graph attribute information format supported by software that bears the network conference.

With reference to any one of five possible implementation manners of the first aspect, after the sending a conference reservation request to a conference reservation server, the method further includes:

acquiring graphical and text information from a graph and text shared area in the network conference; and

uploading the graphical and text information to the conference reservation server, so that the conference reservation server sends a conference minute mail to the terminal participating in the network conference, where the conference minute mail includes a storage address of the graphical and text information on the conference reservation server.

With reference to any one specific implementation manner of the five possible implementation manners of the first aspect, before the acquiring graphical and text information from a graph and text shared area in the network conference, the method further includes:

loading the mail information into the graph and text shared area, so that the terminal participating in the network conference modifies, by using an annotation function of the graph and text shared area, mail content corresponding to the mail information.

According to a first possible implementation manner of a second aspect of the present application, the present application provides an apparatus for initiating a network conference, where the apparatus includes:

an acquiring unit, configured to acquire mail information related to the network conference;

an identifying unit, configured to identify sender address information, recipient address information, and mail title information in the mail information;

a determining unit, configured to determine a sender address indicated by the sender address information as a first participant address of the network conference;

further configured to determine a recipient address indicated by the recipient address information as a second participant address of the network conference; and

further configured to determine a mail title indicated by the mail title information as a conference subject of the network conference; and

a sending unit, configured to send a conference reservation request to a conference reservation server, where the conference reservation request includes the conference subject, the first participant address and the second participant address, and the conference reservation request is used to request the conference reservation server to create the network conference and send a conference notification that includes the conference subject to the first participant address and the second participant address.

With reference to a second possible implementation manner of the second aspect, the sending unit is further configured to:

after sending the conference reservation request to the conference reservation server, upload the mail information to the conference reservation server, so that a terminal participating in the network conference acquires the mail information from the conference reservation server.

With reference to a first specific implementation manner of the second possible implementation manner of the second aspect, the sending unit is specifically configured to:

send a conference reservation request that includes a conference type identifier to the conference reservation server, where the conference type identifier is used to indicate that the network conference is initiated based on a mail, so that the conference reservation server sends the conference type identifier to the terminal participating in the network conference, and after the terminal participating in the network conference determines, according to the conference type identifier, that the network conference is initiated based on a mail, the terminal performs a step of acquiring the mail information from the conference reservation server.

With reference to a second specific implementation manner of the second possible implementation manner of the second aspect, the identifying unit is further configured to:

before the mail information is uploaded to the conference reservation server, identify text information in the mail information;

the determining unit is further configured to determine text attribute information of the text information, where the text attribute information includes at least a font type, a font size, a font color, and a text location; and

the apparatus further includes:

a first converting unit, configured to convert a format of the text attribute information into a text attribute information format supported by software that bears the network conference.

With reference to a third specific implementation manner of the second possible implementation manner of the second aspect, the identifying unit is specifically configured to:

before the mail information is uploaded to a server that is configured to process the network conference, identify graphical information in the mail information;

the determining unit is further configured to determine graph attribute information of the graphical information, where the graph attribute information includes at least a graph type, a graph size, and a graph location; and

the apparatus further includes:

a second converting unit, configured to convert a format of the graph attribute information into a graph attribute information format supported by software that bears the network conference.

With reference to any one of five possible implementation manners of the second aspect, the acquiring unit is further configured to:

after the conference reservation request is sent to the conference reservation server, acquire graphical and text information from a graph and text shared area in the network conference; and

the sending unit is further configured to upload the graphical and text information to the conference reservation server, so that the conference reservation server sends a conference minute mail to the terminal participating in the network conference, where the conference minute mail includes a storage address of the graphical and text information on the conference reservation server.

With reference to any one specific implementation manner of the five possible implementation manners of the second aspect, the apparatus further includes:

a loading unit, configured to, before the graphical and text information is acquired from the graph and text shared area in the network conference, load the mail information into the graph and text shared area, so that the terminal participating in the network conference modifies, by using an annotation function of the graph and text shared area, mail content corresponding to the mail information.

According to a first possible implementation manner of a third aspect of the present application, the present application provides a system for initiating network conference, where the system includes a conference initiating terminal and a conference reservation server, where

the conference initiating terminal is configured to: acquire mail information related to the network conference,

identify sender address information, recipient address information, and mail title information in the mail information,

determine a sender address indicated by the sender address information as a first participant address of the network conference,

determine a recipient address indicated by the recipient address information as a second participant address of the network conference,

determining a mail title indicated by the mail title information as a conference subject of the network conference, and

send a conference reservation request to a conference reservation server, where the conference reservation request includes the conference subject, the first participant address and the second participant address; and

the conference reservation server is configured to, after receiving the conference reservation request, create the network conference and send a conference notification that includes the conference subject to the first participant address and the second participant address.

With reference to a second possible implementation manner of the third aspect, the conference initiating terminal is further configured to, after sending the conference reservation request to the conference reservation server, upload the mail information to the conference reservation server; and

the system further includes a terminal participating in the network conference, where

the terminal participating in the network conference is configured to acquire the mail information from the conference reservation server.

With reference to a first specific implementation manner of the second possible implementation manner of the third aspect, the conference initiating terminal is specifically configured to send a conference reservation request that includes a conference type identifier to the conference reservation server, where the conference type identifier is used to indicate that the network conference is initiated based on a mail;

the conference reservation server is further configured to send the conference type identifier to the terminal participating in the network conference; and

the terminal of the network conference is further configured to, after it is determined, according to the conference type identifier, that the network conference is initiated based on a mail, perform a step of acquiring the mail information from the conference reservation server.

With reference to any one of three possible implementation manners of the third aspect, the conference initiating terminal is further configured to:

after sending the conference reservation request to the conference reservation server, acquire graphical and text information from a graph and text shared area in the network conference, and

upload the graphical and text information to the conference reservation server; and

the conference reservation server is further configured to send a conference minute mail to the terminal participating in the network conference, where the conference minute mail includes a storage address of the graphical and text information on the conference reservation server.

According to specific embodiments provided in the present application, the present application discloses the following technical effects:

According to the method or the apparatus for initiating a network conference disclosed in the present application, the sender address indicated by the sender address information is determined as the first participant address of the network conference; the recipient address indicated by the recipient address information is determined as the second participant address of the network conference; and the mail title indicated by the mail title information is determined as the conference subject of the network conference. Therefore, information related to the network conference may be automatically generated, so that an initiator of the network conference does not need to manually enter participant address information and title information of the network conference, thereby improving efficiency of initiating the network conference.

### BRIEF DESCRIPTION OF DRAWINGS

To describe the technical solutions in the embodiments of the present application or in the prior art more clearly, the following briefly introduces the accompanying drawings required for describing the embodiments. Apparently, the accompanying drawings in the following description show merely some embodiments of the present application, and a person of ordinary skill in the art may still derive other drawings from these accompanying drawings without creative efforts.

FIG. 1 is a flowchart of Embodiment 1 of a method for initiating a network conference according to the present application;

FIG. 2 is a flowchart of Embodiment 2 of a method for initiating a network conference according to the present application;

FIG. 3 is a structural diagram of Embodiment 1 of an apparatus for initiating a network conference according to the present application;

FIG. 4 is a structural diagram of an embodiment of a system for initiating a network conference according to the present application; and

FIG. 5 is a structural diagram of a computing node according to the present application.

### DESCRIPTION OF EMBODIMENTS

The following clearly describes the technical solutions in the embodiments of the present application with reference to the accompanying drawings in the embodiments of the present application. Apparently, the described embodiments are merely some but not all of the embodiments of the present application. All other embodiments obtained by a person of ordinary skill in the art based on the embodiments of the present application without creative efforts shall fall within the protection scope of the present application.

To make the objectives, characteristics, and advantages of the present application clearer to understand, the following further describes the present application in detail with reference to the accompanying drawings and specific implementation manners.

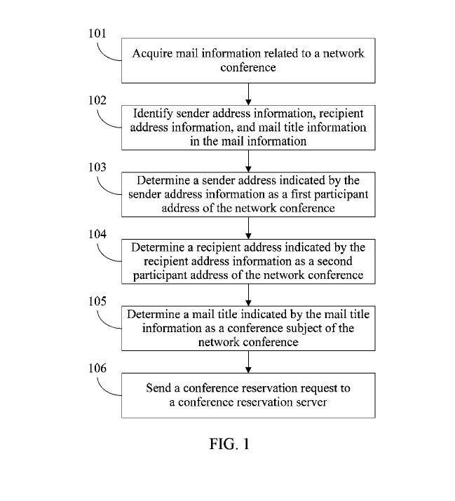

FIG. 1 is a flowchart of Embodiment 1 of a method for initiating a network conference according to the present application. As shown in FIG. 1, the method may include:

Step 101: Acquire mail information related to the network conference.

The network conference in this embodiment of the present application may be initiated for a mail. Information included in the mail related to the network conference may be referred to as mail information related to the network conference.

The mail information related to the network conference may include sender address information, recipient address information, mail title information, mail text information, and the like.

Step 102: Identify the sender address information, the recipient address information, and the mail title information in the mail information.

Step 103: Determine a sender address indicated by the sender address information as a first participant address of the network conference.

There may be multiple participants in the network conference. Generally, a sender of the mail related to the network conference must be included in these participants. Therefore, the sender address indicated by the sender address information may be determined as the first participant address of the network conference. The sender address may be an email box of the sender.

Step 104: Determine a recipient address indicated by the recipient address information as a second participant address of the network conference.

There may be multiple participants in the network conference. Generally, a recipient of the mail related to the network conference must also be included in these participants. Therefore, the recipient address indicated by the recipient address information may be determined as the second participant address of the network conference. The recipient address may be an email box of the recipient.

Step 105: Determine a mail title indicated by the mail title information as a conference subject of the network conference.

Because the network conference may be a discussion initiated for a related mail, a title of the related mail may also be used as a conference subject of the network conference. Therefore, the mail title indicated by the mail title information may be determined as the conference subject of the network conference.

Step 106: Send a conference reservation request to a conference reservation server, where the conference reservation request includes the conference subject, the first participant address and the second participant address. The conference reservation request is used to request the conference reservation server to create the network conference and send a conference notification that includes the conference subject to the first participant address and the second participant address.

The conference reservation request may be sent to the conference reservation server. The conference reservation server may send, according to the first participant address and the second participant address, the conference notification to a first terminal corresponding to the first participant address and a second terminal corresponding to the second participant address, so as to notify the first terminal and the second terminal to participate in the network conference.

The conference notification may include the conference subject, and after receiving this conference notification, the first terminal and the second terminal may display the conference subject on a local display unit, to prompt a user for the subject of the conference.

In conclusion, in this embodiment, the sender address indicated by the sender address information is determined as the first participant address of the network conference, the recipient address indicated by the recipient address information is determined as the second participant address of the network conference, and the mail title indicated by the mail title information is determined as the conference subject of the network conference. Therefore, information related to the network conference may be automatically generated, so that an initiator of the network conference does not need to manually enter participant address information and title information of the network conference, thereby improving efficiency of initiating the network conference.

It should be noted that, in the method in this embodiment, after the first participant address and the second participant address are determined, the user may further manually modify a participant address, so as to add an address of another participant that needs to participate in the network conference. After the conference subject is determined, the user may also manually modify the conference subject.

In an actual application, the network conference is initiated for the mail information; therefore, the mail information needs to be shared among participants of the network conference, so that the participants can learn the mail information. In order to share the mail information, after the conference reservation request is sent to the conference reservation server, the method may further include the following step:

Upload the mail information to the conference reservation server, so that a terminal participating in the network conference acquires the mail information from the conference reservation server.

Specifically, the sending a conference reservation request to a conference reservation server may include:

sending a conference reservation request that includes a conference type identifier to the conference reservation server, where the conference type identifier is used to indicate that the network conference is initiated based on a mail, so that the conference reservation server sends the conference type identifier to the terminal participating in the network conference, and after the terminal participating in the network conference determines, according to the conference type identifier, that the network conference is initiated based on a mail, the terminal performs a step of acquiring the mail information from the conference reservation server.

After receiving the conference type identifier, the terminal participating in the network conference may determine, according to the conference type identifier, that the network conference is initiated based on a mail, and then may download the mail information from the conference reservation server; and the mail information may be displayed on the terminal participating in the network conference. For example, text content of the mail information may be displayed on the participant terminal, so that the participant of the network conference may directly and quickly learn content of the conference.

The conference reservation server may also send a URL that stores the mail information to the terminal participating in the network conference, and the terminal downloads the mail information from the conference reservation server by using the URL.

In a specific implementation manner, after the conference reservation server receives the conference reservation request that includes the conference type identifier, the conference type identifier and the URL that stores the mail information are carried in the sent conference notification; and a terminal that receives the conference notification determines, according to the conference type identifier, that the network conference is initiated based on a mail, and then may download the mail information from the conference reservation server by using the URL.

In another specific implementation manner, a terminal that receives the conference notification sends a conference participation request to the conference reservation server. After receiving the conference participation request, the conference reservation server sends the conference type identifier and the URL that stores the mail information to the conference terminal; and the conference terminal determines, according to the conference type identifier, that the network conference is initiated based on a mail, and then may download the mail information from the conference reservation server by using the URL.

In an actual application, in order that an attribute of the mail information displayed on the participant terminal is consistent with an attribute of text information in the original mail information, before the mail information is uploaded to a server that is configured to process the network conference, the method may further include the following steps:

Identify the text information in the mail information.

Determine text attribute information of the text information, where the text attribute information includes at least a font type, a font size, a font color, and a text location.

Convert a format of the text attribute information into a text format supported by software that bears the network conference. The text format supported by the software that bears the network conference may be a whiteboard format.

In an actual application, in order that an attribute of the mail information displayed on the participant terminal is consistent with an attribute of graphical information in the original mail information, before the mail information is uploaded to a server that is configured to process the network conference, the method may further include the following steps:

Identify graphical information in the mail information.

Determine graph attribute information of the graphical information, where the graph attribute information includes at least a graph type, a graph size, and a graph location.

Convert a format of the graph attribute information into a graph format supported by software that bears the network conference (for example, a whiteboard format).

In an actual application, in order to generate a conference minute according to the content of the network conference so that the content of the network conference can be viewed later, after the conference notification that includes the conference subject is sent to the first participant address and the second participant address, the method may further include the following steps:

Acquire graphical and text information from a graph and text shared area in the network conference.

Upload the graphical and text information to the server.

Send a conference minute mail to the participant terminal, where the conference minute mail includes a storage address of the graphical and text information on the server.

The graph and text shared area may also be referred to as a whiteboard. In the network conference, both speech of a participant and text and graphical information displayed in the conference may be displayed in the graph and text shared area. Therefore, the text and graphical information may be used as the conference minute of the network conference. In specific implementation, the terminal participating in the conference may load, on the whiteboard, mail information whose format is converted into a whiteboard format, and participants have a discussion about mail content. During the conference, the participant may modify the mail information by using a whiteboard annotation function and use modified mail information as the conference minute.

It should be noted that, the conference minute mail includes the storage address of the graphical and text information on the server, but not the graphical and text information. A data volume occupied by the storage address is far smaller than a data volume of the graphical and text information. Therefore, sending the conference minute mail that includes the storage address may further reduce a data volume of the conference minute mail, which avoids network congestion caused by transmission of a large volume of data.

In an actual application, a user corresponding to a participant terminal may be absent from the network conference due to a reason. Therefore, sending the conference minute mail to the participant terminal who is absent from the network conference may make the user who is absent from the network conference learn the conference content of the network conference.

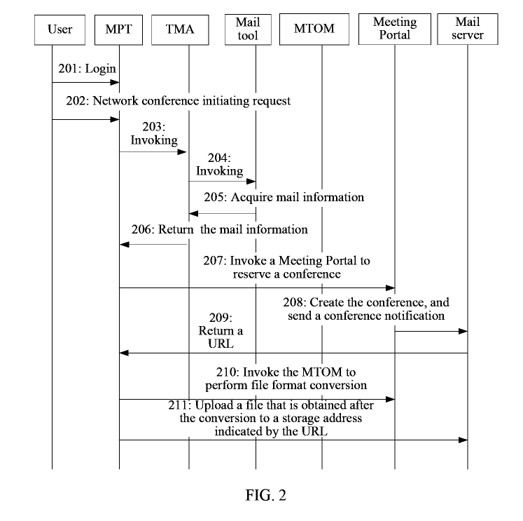

FIG. 2 is a flowchart of Embodiment 2 of a method for initiating a network conference according to the present application. As shown in FIG. 2, the method may include:

Step 201: A user logs in to meeting productivity tools (Meeting Productivity Tools, MPT) software.

MPT is software that can execute the method of the present application. When using the MPT for the first time, information related to the network conference may be configured, where the related information may include an IP address and a port number of a conference reservation server; and a default conference parameter may further be created, where the default conference parameter includes but is not limited to a default quantity of conference participants, conference duration information, a conference mode (a host mode or a free mode), and the like.

Step 202: The user initiates a network conference initiating request that is based on mail information.

The user may initiate the request by clicking a “conference reservation” plug-in button on a mail page.

Step 203: The MPT invokes a third-party mail system adaptation unit (Third mail adapter, TMA) interface, so as to acquire related information in a mail, where the related information includes a mail sender field, a mail recipient field, a mail title, and mail text.

The TMA is a module defined in the present application, and may be configured to: shield a difference between bottom mail systems; acquire information such as a sender, a subject, and mail content of a mail; and send the information to the MPT. The MPT automatically fills the foregoing information into a conference reservation page. The user may rapidly initiate the network conference by using the foregoing information, or the user may reserve the conference after modifying a part of the information.

Step 204: The TMA invokes an interface of a mail tool according to a type of the mail tool.

The mail tool refers to a software tool that is used to send and receive a related mail. The mail tool may be Outlook, Foxmail, and the like. After the interface of the mail tool is invoked, mail information related to the network conference may be read from the mail tool.

Step 205: The TMA acquires the mail information related to the network conference from the mail tool.

Step 206: The TMA returns the mail information to the MPT, where the MPT uses a mail sender and a mail recipient as participants of the conference, and uses a mail title as a conference subject. The user may make a few modifications to the participants and the conference subject, and manually enters a conference start time.

Step 207: The MPT invokes a conference creating interface of the conference reservation server (for example, a meeting portal Meeting Portal) to reserve the conference.

In a creating process, a conference type may further be identified, and the network conference that is initiated based on a mail is identified. An identifier is a conference type identifier, where the conference type identifier may be included in a conference notification. As long as a participant terminal identifies the identifier, the participant terminal may determine that a step of downloading the mail information related to the network conference from the conference reservation server needs to be performed.

It should also be noted that, when the conference creating interface is invoked to create the conference, the MPT may send a URL that stores a related mail to the Meeting Portal for storage. Subsequently, when sending a conference minute, the Meeting Portal may add the URL to the mail.

Step 208: After successfully creating the conference, the Meeting Portal sends a conference notification to all participant terminals by using a mail server.

In this step, a URL used to store the mail information related to the network conference may further be generated. In this embodiment, both related mail information and graphical and text information included in a conference minute mail may be stored in a storage address corresponding to the URL.

Step 209: The Meeting Portal returns the URL to the MPT.

Step 210: The MPT invokes the mail to a conference converting module (Mail to Meeting, MTOM) interface, and converts a format of mail content into a file format supported by software that bears the network conference.

Step 211: The MPT uploads the file that is obtained after the conversion to the storage address indicated by the URL.

In this embodiment, the mail information related to the network conference may be acquired by using the TMA, and the related information in the mail information is determined as a conference subject and a participant address of the network conference. Therefore, an operation of manually entering information such as the conference subject and the participant address by a user may be omitted. The format of the mail content corresponding to the mail information may be converted, by using the MTOM, into the file format supported by the software that bears the network conference, thereby implementing that the mail content is shared and displayed on a participant terminal.

The present application further provides an apparatus for initiating a network conference.

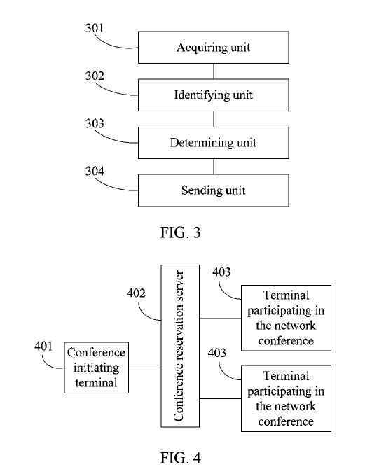

FIG. 3 is a structural diagram of Embodiment 1 of an apparatus for initiating a network conference according to the present application. As shown in FIG. 3, the apparatus may include: an acquiring unit 301, an identifying unit 302, a determining unit 303, and a sending unit 304.

The acquiring unit 301 is configured to acquire mail information related to the network conference.

The network conference in this embodiment of the present application may be initiated for a mail. Information included in the mail related to the network conference may be referred to as mail information related to the network conference.

The mail information related to the network conference may include sender address information, recipient address information, mail title information, mail text information, and the like.

The identifying unit 302 is configured to identify the sender address information, the recipient address information, and the mail title information in the mail information.

The determining unit 303 is configured to determine a sender address indicated by the sender address information as a first participant address of the network conference.

There may be multiple participants in the network conference. Generally, a sender of the mail related to the network conference must be included in these participants. Therefore, the sender address indicated by the sender address information may be determined as the first participant address of the network conference. The sender address may be an email box of the sender.

The determining unit 303 is further configured to determine a recipient address indicated by the recipient address information as a second participant address of the network conference.

There may be multiple participants in the network conference. Generally, a recipient of the mail related to the network conference must also be included in these participants. Therefore, the recipient address indicated by the recipient address information may be determined as the second participant address of the network conference. The recipient address may be an email box of the recipient.

The determining unit 303 is further configured to determine a mail title indicated by the mail title information as a conference subject of the network conference.

Because the network conference may be a discussion initiated for a related mail, a title of the related mail may also be used as a conference subject of the network conference. Therefore, the mail title indicated by the mail title information may be determined as the conference subject of the network conference.

The sending unit 304 is configured to send a conference reservation request to a conference reservation server, where the conference reservation request includes the conference subject, the first participant address and the second participant address. The conference reservation request is used to request the conference reservation server to create the network conference and send a conference notification that includes the conference subject to the first participant address and the second participant address.

The conference reservation request may be sent to the conference reservation server. The conference reservation server may send, according to the first participant address and the second participant address, the conference notification to a first terminal corresponding to the first participant address and a second terminal corresponding to the second participant address, so as to notify the first terminal and the second terminal to participate in the network conference.

The conference notification may include the conference subject, and after receiving this conference notification, the first terminal and the second terminal may display the conference subject on a local display unit, to prompt a user for the subject of the conference.

In conclusion, in this embodiment, the sender address indicated by the sender address information is determined as the first participant address of the network conference, the recipient address indicated by the recipient address information is determined as the second participant address of the network conference, and the mail title indicated by the mail title information is determined as the conference subject of the network conference. Therefore, information related to the network conference may be automatically generated, so that an initiator of the network conference does not need to manually enter participant address information and title information of the network conference, thereby improving efficiency of initiating the network conference.

It should be noted that, in the apparatus in this embodiment, after the first participant address and the second participant address are determined, the user may further manually modify a participant address, so as to add an address of another participant that needs to participate in the network conference. After the conference subject is determined, the user may also manually modify the conference subject.

In an actual application, the network conference is initiated for the mail information; therefore, the mail information needs to be shared among participants of the network conference, so that the participants can learn the mail information. In order to share the mail information, the sending unit 304 may further be configured to:

after sending the conference reservation request to the conference reservation server, upload the mail information to the conference reservation server, so that a terminal participating in the network conference acquires the mail information from the conference reservation server.

The sending unit may specifically be configured to:

send a conference reservation request that includes a conference type identifier to the conference reservation server, so that the conference reservation server adds the conference type identifier to the conference notification, and after identifying the conference type identifier, the terminal participating in the network conference performs a step of acquiring the mail information from the conference reservation server.

The conference type identifier is used to indicate that the network conference is initiated based on a mail.

After receiving the conference notification, the terminal participating in the network conference may identify the conference type identifier. As long as the conference type identifier is identified, the terminal participating in the network conference may download the mail information from the server; and the mail information may be displayed on the terminal participating in the network conference. For example, text content of the mail information may be displayed on the participant terminal, so that the participant of the network conference may directly and quickly learn content of the conference.

In an actual application, in order that an attribute of the mail information displayed on the participant terminal is consistent with an attribute of text information in the original mail information, the identifying unit 302 may further be configured to:

before the mail information is uploaded to the conference reservation server, identify the text information in the mail information.

The determining unit 303 may further be configured to determine text attribute information of the text information, where the text attribute information includes at least a font type, a font size, a font color, and a text location.

The apparatus may further include:

a first converting unit, configured to convert a format of the text attribute information into a text attribute information format supported by software that bears the network conference.

In an actual application, in order that an attribute of the mail information displayed on the participant terminal is consistent with an attribute of graphical information in the original mail information, the identifying unit 302 may further be configured to:

before the mail information is uploaded to the conference reservation server, identify graphical information in the mail information.

The determining unit 303 may further be configured to determine graph attribute information of the graphical information, where the graph attribute information includes at least a graph type, a graph size, and a graph location.

The apparatus may further include:

a second converting unit, configured to convert a format of the graph attribute information into a graph attribute information format supported by software that bears the network conference.

In an actual application, in order to generate a conference minute according to the content of the network conference, so that the content of the network conference can be viewed later, the acquiring unit 301 may further be configured to:

after the conference reservation request is sent to the conference reservation server, acquire graphical and text information from a graph and text shared area in the network conference.

The sending unit 304 may further be configured to upload the graphical and text information to the conference reservation server, so that the conference reservation server sends a conference minute mail to the terminal participating in the network conference, where the conference minute mail includes a storage address of the graphical and text information on the conference reservation server.

The graph and text shared area may also be referred to as a whiteboard. In the network conference, both speech of a participant and text and graphical information displayed in the conference may be displayed in the graph and text shared area. Therefore, the text and graphical information may be used as the conference minute of the network conference.

It should be noted that, the conference minute mail includes the storage address of the graphical and text information on the server, but not the graphical and text information. A data volume occupied by the storage address is far smaller than a data volume of the graphical and text information. Therefore, sending the conference minute mail that includes the storage address may further reduce a data volume of the conference minute mail, which avoids network congestion caused by transmission of a large volume of data.

In an actual application, a user corresponding to a participant terminal may be absent from the network conference due to a reason. Therefore, sending the conference minute mail to the participant terminal who is absent from the network conference may make the user who is absent from the network conference learn the conference content of the network conference.

In an actual application, the apparatus may further include:

a loading unit, configured to, before the graphical and text information is acquired from the graph and text shared area in the network conference, load the mail information into the graph and text shared area, so that the terminal participating in the network conference modifies, by using an annotation function of the graph and text shared area, mail content corresponding to the mail information.

The present application further provides a system for initiating a network conference. FIG. 4 is a structural diagram of an embodiment of a system for initiating a network conference according to the present application. As shown in FIG. 4, the system may include a conference initiating terminal 401 and a conference reservation server 402.

The conference initiating terminal 401 is configured to: acquire mail information related to the network conference;

identify sender address information, recipient address information, and mail title information in the mail information;

determine a sender address indicated by the sender address information as a first participant address of the network conference;

determine a recipient address indicated by the recipient address information as a second participant address of the network conference;

determine a mail title indicated by the mail title information as a conference subject of the network conference; and

send a conference reservation request to a conference reservation server, where the conference reservation request includes the conference subject, the first participant address and the second participant address.

The conference reservation server 402 is configured to, after receiving the conference reservation request, create the network conference and send a conference notification that includes the conference subject to the first participant address and the second participant address.

In conclusion, in this embodiment, the sender address indicated by the sender address information is determined as the first participant address of the network conference, the recipient address indicated by the recipient address information is determined as the second participant address of the network conference, and the mail title indicated by the mail title information is determined as the conference subject of the network conference. Therefore, information related to the network conference may be automatically generated, so that an initiator of the network conference does not need to manually enter participant address information and title information of the network conference, thereby improving efficiency of initiating the network conference.

In an actual application, the conference initiating terminal 401 is further configured to, after sending the conference reservation request to the conference reservation server 402, upload the mail information to the conference reservation server 402; and

the system further includes a terminal 403 participating in the network conference, where

the terminal 403 participating in the network conference is configured to acquire the mail information from the conference reservation server 402.

In an actual application, the conference initiating terminal 401 is specifically configured to send a conference reservation request that includes a conference type identifier to the conference reservation server 402, where the conference type identifier is used to indicate that the network conference is initiated based on a mail;

the conference reservation server 402 is further configured to send the conference type identifier to the terminal participating in the network conference; and

the terminal of the network conference is further configured to, after it is determined, according to the conference type identifier, that the network conference is initiated based on a mail, perform a step of acquiring the mail information from the conference reservation server 402.

In an actual application, the conference initiating terminal 401 is further configured to:

after sending the conference reservation request to the conference reservation server 402, acquire graphical and text information from a graph and text shared area in the network conference, and

upload the graphical and text information to the conference reservation server 402; and

the conference reservation server 402 is further configured to send a conference minute mail to the terminal 403 participating in the network conference, where the conference minute mail includes a storage address of the graphical and text information on the conference reservation server 402.

In addition, an embodiment of the present application further provides a computing node, where the computing node may be a host server that has a computing capability, a personal computer PC, a portable computer, a terminal, or the like. Specific implementation of the computing node is not limited in a specific embodiment of the present application.

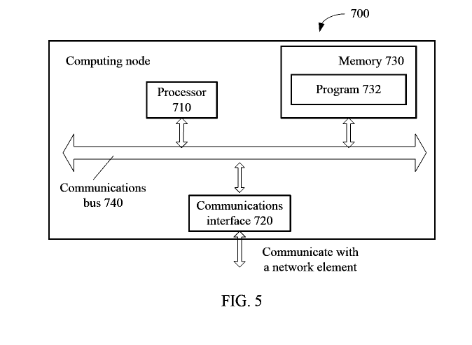

FIG. 5 is a structural diagram of a computing node according to the present application. As shown in FIG. 5, a computing node 700 includes:

a processor (processor) 710, a communications interface (Communications Interface) 720, a memory (memory) 730, and a bus 740.

The processor 710, the communications interface 720, and the memory 730 complete mutual communication by using the bus 740.

The processor 710 is configured to execute a program 732.

Specifically, the program 732 may include program code, where the program code includes a computer operation instruction.

The processor 710 may be a central processing unit CPU, or an application specific integrated circuit ASIC (Application Specific Integrated Circuit), or one or multiple integrated circuits configured to implement the embodiments of the present application.

The memory 730 is configured to store the program 732. The memory 730 may include a high-speed RAM memory, or may include a nonvolatile memory (non-volatile memory), for example, at least one disk memory. The program 732 may specifically includes the corresponding module or unit in the embodiment shown in FIG. 3, and details are not described herein.

Finally, it should be noted that in this specification, relational terms such as first and second are only used to distinguish one entity or operation from another, and do not necessarily require or imply that any actual relationship or sequence exists between these entities or operations. Moreover, the terms “include”, “comprise”, or their any other variant is intended to cover a non-exclusive inclusion, so that a process, a method, an article, or an apparatus that includes a list of elements not only includes those elements but also includes other elements that are not expressly listed, or further includes elements inherent to such process, method, article, or apparatus. An element preceded by “includes a . . . ” does not, without more constraints, preclude the existence of additional identical elements in the process, method, article, or apparatus that includes the element.

According to the foregoing descriptions of the embodiments, a person skilled in the art may clearly understand that the present application may be implemented by software in addition to a necessary hardware platform or by hardware only. In most circumstances, the former is a preferred implementation manner. Based on such an understanding, all or a part of the technical solutions of the present application contributing to the technology in the background part may be implemented in a form of a software product. The software product may be stored in a storage medium, such as a ROM/RAM, a magnetic disk, or an optical disc, and includes several instructions for instructing a computer device (which may be a personal computer, a server, or a network device) to perform the methods described in the embodiments or some parts of the embodiments of the present application.

The embodiments in this specification are all described in a progressive manner, each embodiment focuses on a difference from other embodiments, and for same or similar parts in the embodiments, reference may be made to these embodiments. The apparatus disclosed in the embodiment is basically similar to the method disclosed in the embodiment, and therefore is described briefly; for related parts, reference may be made to the description in the method part.

Specific examples are used in this specification to describe the principle and implementation manners of the present application. The foregoing embodiments are merely intended to help understand the method and core idea of the present application. In addition, with respect to the implementation manners and the application scope, modifications may be made by a person of ordinary skill in the art according to the idea of the present application. Therefore, the content of this specification shall not be construed as a limitation to the present application.

What is claimed is:

1. A method for initiating a network conference, comprising:
acquiring mail information related to the network conference;
identifying sender address information, recipient address information, and mail title information in the mail information;
determining a sender address indicated by the sender address information as a first participant address of the network conference;
determining a recipient address indicated by the recipient address information as a second participant address of the network conference;
determining a mail title indicated by the mail title information as a conference subject of the network conference; and
sending a conference reservation request to a conference reservation server, wherein the conference reservation request comprises the conference subject, the first participant address and the second participant address, and the conference reservation request is used to request the conference reservation server to create the network conference and send a conference notification that comprises the conference subject to the first participant address and the second participant address;
acquiring graphical and text information from a graph and text shared area in the network conference; and
uploading the graphical and text information to the conference reservation server, so that the conference reservation server sends a conference minute mail to the terminal participating in the network conference, wherein the conference minute mail comprises a storage address of the graphical and text information on the conference reservation server.

2. The method according to claim 1, wherein after the sending a conference reservation request to a conference reservation server, the method further comprises:
uploading the mail information to the conference reservation server, so that a terminal participating in the network conference acquires the mail information from the conference reservation server.

3. The method according to claim 2, wherein the sending a conference reservation request to a conference reservation server specifically comprises:
sending a conference reservation request that comprises a conference type identifier to the conference reservation server, wherein the conference type identifier is used to indicate that the network conference is initiated based on a mail, so that the conference reservation server sends the conference type identifier to the terminal participating in the network conference, and after the terminal participating in the network conference determines, according to the conference type identifier, that the network conference is initiated based on a mail, the terminal performs a step of acquiring the mail information from the conference reservation server.

4. The method according to claim 2, wherein before the uploading the mail information to the conference reservation server, the method further comprises:
identifying text information in the mail information;
determining text attribute information of the text information, wherein the text attribute information comprises at least a font type, a font size, a font color, and a text location; and
converting a format of the text attribute information into a text attribute information format supported by software that bears the network conference.

5. The method according to claim 2, wherein before the uploading the mail information to the conference reservation server, the method further comprises:
identifying graphical information in the mail information;
determining graph attribute information of the graphical information, wherein the graph attribute information comprises at least a graph type, a graph size, and a graph location; and
converting a format of the graph attribute information into a graph attribute information format supported by software that bears the network conference.

6. The method according to claim 1, wherein before the acquiring graphical and text information from a graph and text shared area in the network conference, the method further comprises:
loading the mail information into the graph and text shared area, so that the terminal participating in the network conference modifies, by using an annotation function of the graph and text shared area, mail content corresponding to the mail information.

7. An apparatus for initiating a network conference, comprising:
an acquiring unit, configured to acquire mail information related to the network conference;
an identifying unit, configured to identify sender address information, recipient address information, and mail title information in the mail information;
a determining unit, configured to determine a sender address indicated by the sender address information as a first participant address of the network conference;
further configured to determine a recipient address indicated by the recipient address information as a second participant address of the network conference; and
further configured to determine a mail title indicated by the mail title information as a conference subject of the network conference; and
a sending unit, configured to send a conference reservation request to a conference reservation server, wherein the conference reservation request comprises the conference subject, the first participant address and the second participant address, and the conference reservation request is used to request the conference reservation server to create the network conference and send a conference notification that comprises the conference subject to the first participant address and the second participant address.

8. The apparatus according to claim 7, wherein the sending unit is further configured to:
after sending the conference reservation request to the conference reservation server, upload the mail information to the conference reservation server, so that a terminal participating in the network conference acquires the mail information from the conference reservation server.

9. The apparatus according to claim 8, wherein the sending unit is specifically configured to:
send a conference reservation request that comprises a conference type identifier to the conference reservation server, wherein the conference type identifier is used to indicate that the network conference is initiated based on a mail, so that the conference reservation server sends the conference type identifier to the terminal participating in the network conference, and after the terminal participating in the network conference determines, according to the conference type identifier, that the network conference is initiated based on a mail, the terminal performs a step of acquiring the mail information from the conference reservation server.

10. The apparatus according to claim 8, wherein the identifying unit is further configured to:
before the mail information is uploaded to the conference reservation server, identify text information in the mail information;
the determining unit is further configured to determine text attribute information of the text information, wherein the text attribute information comprises at least a font type, a font size, a font color, and a text location; and
the apparatus further comprises:
a first converting unit, configured to convert a format of the text attribute information into a text attribute information format supported by software that bears the network conference.

11. The apparatus according to claim 8, wherein the identifying unit is further configured to:
before the mail information is uploaded to a server that is configured to process the network conference, identify graphical information in the mail information;
the determining unit is further configured to determine graph attribute information of the graphical information, wherein the graph attribute information comprises at least a graph type, a graph size, and a graph location; and
the apparatus further comprises:
a second converting unit, configured to convert a format of the graph attribute information into a graph attribute information format supported by software that bears the network conference.

12. The apparatus according to claim 7, wherein the acquiring unit is further configured to:
after the conference reservation request is sent to the conference reservation server, acquire graphical and text information from a graph and text shared area in the network conference; and
the sending unit is further configured to upload the graphical and text information to the conference reservation server, so that the conference reservation server sends a conference minute mail to the terminal participating in the network conference, wherein the conference minute mail comprises a storage address of the graphical and text information on the conference reservation server.

13. The apparatus according to claim 12, further comprising:
a loading unit, configured to, before the graphical and text information is acquired from the graph and text shared area in the network conference, load the mail information into the graph and text shared area, so that the terminal participating in the network conference modifies, by using an annotation function of the graph and text shared area, mail content corresponding to the mail information.

14. A system for initiating a network conference, comprising a conference initiating terminal and a conference reservation server, wherein
the conference initiating terminal is configured to: acquire mail information related to the network conference,
identify sender address information, recipient address information, and mail title information in the mail information,
determine a sender address indicated by the sender address information as a first participant address of the network conference,
determine a recipient address indicated by the recipient address information as a second participant address of the network conference,
determine a mail title indicated by the mail title information as a conference subject of the network conference, and
send a conference reservation request to a conference reservation server, wherein the conference reservation request comprises the conference subject, the first participant address and the second participant address; and
the conference reservation server is configured to, after receiving the conference reservation request, create the network conference and send a conference notification that comprises the conference subject to the first participant address and the second participant address.

15. The system according to claim 14, wherein the conference initiating terminal is further configured to, after sending the conference reservation request to the conference reservation server, upload the mail information to the conference reservation server; and
the system further comprises a terminal participating in the network conference, wherein
the terminal participating in the network conference is configured to acquire the mail information from the conference reservation server.

16. The system according to claim 15, wherein the conference initiating terminal is specifically configured to send a conference reservation request that comprises a conference type identifier to the conference reservation server, wherein the conference type identifier is used to indicate that the network conference is initiated based on a mail;
the conference reservation server is further configured to send the conference type identifier to the terminal participating in the network conference; and
the terminal of the network conference is further configured to, after it is determined, according to the conference type identifier, that the network conference is initiated based on a mail, perform a step of acquiring the mail information from the conference reservation server.

17. The system according to claim 14, wherein the conference initiating terminal is further configured to:
after sending the conference reservation request to the conference reservation server, acquire graphical and text information from a graph and text shared area in the network conference, and
upload the graphical and text information to the conference reservation server; and
the conference reservation server is further configured to send a conference minute mail to the terminal participating in the network conference, wherein the conference minute mail comprises a storage address of the graphical and text information on the conference reservation server.
